(19) United States
(12) Patent Application Publication
(10) Pub. No.: US 2023/0056103 A1
(43) Pub. Date: Feb. 23, 2023

(54) APPARATUS AND METHOD FOR FREIGHT DELIVERY AND PICK-UP

(71) Applicant: CRC R&D, LLC, Kenner, LA (US)

(72) Inventors: Ronald H. Mains, Kenner, LA (US); Chathan Mangat, New Orleans, LA (US); Kenneth John Guillot, JR., Metairie, LA (US); Mark Michael West, Saint Petersburg, FL (US)

(21) Appl. No.: 17/888,690

(22) Filed: Aug. 16, 2022

Related U.S. Application Data
(60) Provisional application No. 63/234,005, filed on Aug. 17, 2021.

(51) Int. Cl. G06Q 10/08; G06Q 50/30

(52) U.S. Cl. CPC G06Q 10/08355; G06Q 50/30

(57) ABSTRACT

A system includes a loading/unloading facility, a user apparatus having a user interface configured to communicate with a driver of a delivery/pick-up vehicle, and an administrator apparatus configured to communicate with the user apparatus and the loading/unloading facility. The driver checks into the user apparatus and the administrator apparatus coordinates arrival of the delivery/pick-up vehicle at the loading/unloading facility. The driver may check in at the user apparatus without touching the user apparatus and without exiting the vehicle. The driver may receive shipping documents from the user apparatus and may electronically sign the shipping documents without exiting the vehicle.

This application claims benefit of U.S. Provisional Application No. 63/234,005, filed Aug. 17, 2021, the contents of which are incorporated herein by reference.

### CROSS-REFERENCE TO RELATED APPLICATIONS

The subject matter of this application is related to United States Pat. Application having Serial Number 14/790,300, filed on Jul. 2, 2015, and entitled “APPARATUS AND METHOD FOR FREIGHT DELIVERY AND PICK-UP,” and of United States Patent Application having Serial Number 16/119,650, filed Aug. 31, 2018, entitled “MANAGEMENT OF VEHICULAR TRAFFIC AT A FACILITY HAVING ALLOCABLE SPACE RESOURCES,” the entireties of which are incorporated herein by reference.

### BACKGROUND

A constant challenge for an entity operating a warehouse, or other delivery and/or pick-up facility, is to efficiently, safely and securely provide for the delivery and pick-up of goods. “Pick-ups” typically involve bringing a freight vehicle to a warehouse loading bay for loading cargo. “Deliveries” typically involve bringing a loaded freight vehicle to a warehouse loading bay for unloading cargo. Freight vehicles are often relatively large tractor/trailers that require ample space, and pick-ups/deliveries are often scheduled for a fixed fifteen to thirty minute window. Theoretically, during the scheduled window, the inbound freight vehicle, e.g., tractor/trailer, arrives, reports to the guard shack or receiving window, is assigned a loading bay, and then proceeds to the loading bay for loading and/or unloading by warehouse personnel. In certain situations, drivers drive directly to the warehouse or loading bay. Often no prescreening is done to ensure authorization of the driver and load prior to arrival at the warehouse site, loading bay, guard shack, or receiving window.

Furthermore, because travel from a previous destination may involve a journey of hundreds or thousands of miles, it is not uncommon for there to be an early or late arrival at the warehouse. An early or late arriving tractor/trailer may have to wait for many minutes or several hours until its previously scheduled or next available pick-up/delivery window. Scheduling delays may also occur for other reasons, including delays related to warehouse operations, weather, etc. Many facilities, due to high volumes of deliveries and/or limited space availability, frequently experience bottlenecks that result in many logistics issues. Few facilities have sufficient on-site parking available. It is not uncommon for there to be long lines of tractor/trailers either on-site or at the side of a nearby highway or street awaiting the opportunity to pick-up or drop-off cargo. These situations are potentially dangerous, often illegal, and cause problems for other vehicles, businesses and residents in the area.

Furthermore, in many situations, when arriving at a warehouse, a driver must park the vehicle, exit the vehicle, and walk to the guard shack or to an office to check in to the facility, receive an assignment and directions to a loading dock. Similarly, when exiting a warehouse facility, a driver must park the vehicle, exit the vehicle, and walk to the guard shack or to the office to check out, receive paperwork (e.g., Bill of Lading “BOL” or Proof of Delivery “POD”), before exiting the facility.

Accordingly, a need exists for methods, apparatuses, and systems for freight delivery and pickup that reduces scheduling delays and provides prescreening and identity verification. The following description provides these, and numerous other, advantages.

### SUMMARY

In an embodiment of the present disclosure, a system is provided. The system has a user apparatus having a user interface configured to communicate with a driver of a delivery/pick-up vehicle, and an administrator apparatus configured to communicate with the user apparatus and a loading/unloading facility. The user apparatus may be located remotely from the loading/unloading facility and the driver checks into the user apparatus. The administrator apparatus may coordinate arrival of the delivery/pick-up vehicle at the facility.

The user apparatus may obtain from the driver at least one of a check-in time, a pick-up/drop-off time, authorization information, driver identifying information, truck or trailer identifying information, and scale in/weight information. The administrator apparatus may relay to the user apparatus at least one of an assigned loading dock, a loading dock current usage graphic, a pick-up/drop-off time, and an authorized driver release. The system may have a logistics support facility in communication with at least one of the administrator apparatus, user apparatus and facility. The system may have a scale system in communication with at least one of the administrator apparatus, user apparatus and facility. Each of the user apparatus and the administrator apparatus may be in communication with camera systems. The user apparatus may verify driver security information and authorize the driver for delivery at the facility. The administrator apparatus and user apparatus may be located at a same facility. The administrator apparatus and user apparatus may be located at different facilities. The administrator apparatus may be located at the facility.

The system may have a pager system in communication with the driver and the administrator apparatus. The user apparatus may be at least one of a kiosk and a wall mounted display. The user apparatus may include at least one of a card reader, an optical scanner, and a Department of Transportation (“DOT”) number reader. The system may further have an administrator. The administrator may interface with the administrator apparatus, the user apparatus, and the facility, and coordinates the arrival of the vehicle at the facility. The facility may include a sensor to detect the presence of the vehicle at a loading dock located at the facility, wherein the sensor is in communication with the administrator apparatus. The system may further have a DOT reader used to obtain a machine-readable DOT number from an image on the vehicle and pull identifying information of the carrier or the driver from the DOT number.

In an embodiment of the present disclosure, an apparatus is provided. The apparatus has a user system configured to communicate with a driver of a freight delivery/pick-up vehicle and gather information regarding the driver and a delivery/pick-up schedule. The user system may be located remotely from a loading/unloading facility and in communication with the facility and an administrator apparatus. The driver may check into the user system and the administrator apparatus coordinates arrival of the vehicle at the facility. The user system may obtain from the driver at least one of a check-in time, a pick-up/drop-off time, authorization information, driver identifying information, truck or trailer identifying information, and scale in/weight information. The administrator apparatus may relay to the user system at least one of an assigned loading dock, a loading dock current usage graphic, a pick-up/drop-off time, and an authorized driver release.

The apparatus may have a pager system, the pager system including a pager in communication with the administrator apparatus. The apparatus may have a camera system in communication with the administrator apparatus. The apparatus may have at least one of an optical scanner and a DOT reader. The apparatus may further include a card reader configured to identify the driver of the vehicle. The user apparatus may verify driver security information and authorize the driver and cargo for delivery at the facility. The card reader may be a magnetic stripe reader or Transportation Worker Identification Credential (“TWIC”) card reader. The apparatus may have a Voice over Internet Protocol (“VoIP”) intercom system configured for the delivery of audio and multimedia sessions over IP networks. The apparatus may further include a printer located within the apparatus, the printer configured to print relevant documents. The printer may be at least one of a badge printer and a printer configured to print on physical paper, such as, for example, 8 ½” × 11” paper. The apparatus may have a barcode scanner, the barcode scanner configured to read 1D or 2D barcodes on documents containing identifying information.

In an embodiment of the present disclosure, a method for management of freight pick-up and delivery is provided. The method includes checking a driver of a freight delivery/pick-up vehicle into a user apparatus located remotely from a loading/unloading facility; entering driver information into the user apparatus; communicating the driver information to an administrator apparatus in communication with the loading/unloading facility; communicating loading/unloading information from the loading/unloading facility to the administrator apparatus; and utilizing the driver information and the loading/unloading information to coordinate arrival of the delivery/pick-up vehicle at the loading/unloading facility.

### BRIEF DESCRIPTION OF DRAWINGS

FIG. 1 is a schematic of a freight delivery/pick-up system, according to some embodiments.

FIG. 2 is a front view of a user apparatus, according to some embodiments.

FIG. 3 is a schematic of a system, according to some embodiments.

FIG. 4 is a screen view of a user interface of the user apparatus shown in FIG. 2, according to some embodiments.

FIG. 5 is a view of a video call as seen from the user interface shown in FIG. 4, according to some embodiments.

FIG. 6 is a front view of an administrator apparatus, according to some embodiments.

FIG. 7 is a screen view of the administrator apparatus shown in FIG. 6, according to some embodiments.

FIG. 8 is a schematic of multiple user apparatuses and multiple administrator apparatuses, according to some embodiments.

FIG. 9 is a flow chart showing a freight delivery/pick-up system using a dispatch agent, according to some embodiments.

FIG. 10 is a flow chart showing an automated freight delivery/pick-up system, according to some embodiments.

FIG. 11 is a front view of a user apparatus, according to some embodiments.

FIG. 12 is a perspective view of the user apparatus shown in FIG. 11, according to some embodiments.

FIG. 13 is a fragmented close-up front view of the user apparatus shown in FIG. 11, according to some embodiments.

FIG. 14 is a back view of the user apparatus shown in FIG. 11, according to some embodiments.

FIG. 15 is a perspective view of a user apparatus, according to some embodiments.

FIGS. 16A and 16B are flow charts showing an automated freight delivery/pick-up system, according to some embodiments.

FIG. 17 is a process flow diagram for scheduling and completing an inbound shipment with touchless technology, in accordance with some embodiments.

FIG. 18 is a sample screen shot of a check-in verification, according to some embodiments.

FIG. 19 is a sample screen shot of an unloading verification, according to some embodiments.

FIG. 20 is a process flow diagram of a check-out from a facility, according to some embodiments.

FIGS. 21A and 21B are sample screen shots of electronic document interchanges between a driver and a warehouse operator, in accordance with some embodiments.

### DESCRIPTION

The present disclosure provides apparatuses, systems, and methods for remote or off-site check-in of freight vehicles that eliminate many of the problems with current freight delivery and pick-up. Embodiments include custom apparatuses and software that interface as a system to remotely control the logistics of delivery and pick-up of freight, thereby providing for a more efficient, safe and secure use of loading bays and personnel resources. In some specific embodiments, the system provides a simple remote screen interface that allows drivers of freight vehicles to remotely login to the freight management system, become authorized, and coordinate, through the system, efficient delivery and/or pick-up of freight including the handling of freight documents. In many cases, the check in and check out process is touchless and does not require a freight vehicle driver to interact with any personnel at the warehouse location.

The check-in service may be full service and efficiently coordinate, by providing all necessary information, for safe delivery of goods. In many cases, there is no human contact or interaction between the freight driver and the warehouse operators. The remote login/user interface may be located separate from the loading/unloading facility and possibly may be remotely located from an administrator system. The administrator system communicates with the driver/remote user apparatus as well as the loading/unloading facility and coordinates and controls the logistics of the delivery/pick-up. Some or all of this process is automated by the system apparatuses and software.

The remote user interface may be located remotely from the warehouse location, such as at an off-site driver’s lounge that is relatively near the loading/unloading facility. This remote location may be designed to accommodate freight vehicles and personnel, including providing adequate parking and other amenities. In certain embodiments, the driver is provided a pager or is able to use a portable user device (e.g., cellular telephone, smartphone, tablet computer, laptop computer, or any other type of mobile communication device that allows the driver to receive communication or information) which is used to alert the driver a few minutes before a loading bay is available. While waiting, the driver may utilize facilities for refueling, showering, food, rest, and relaxation. The present system avoids potentially dangerous situations where trucks are parked in queues along highways and residential streets.

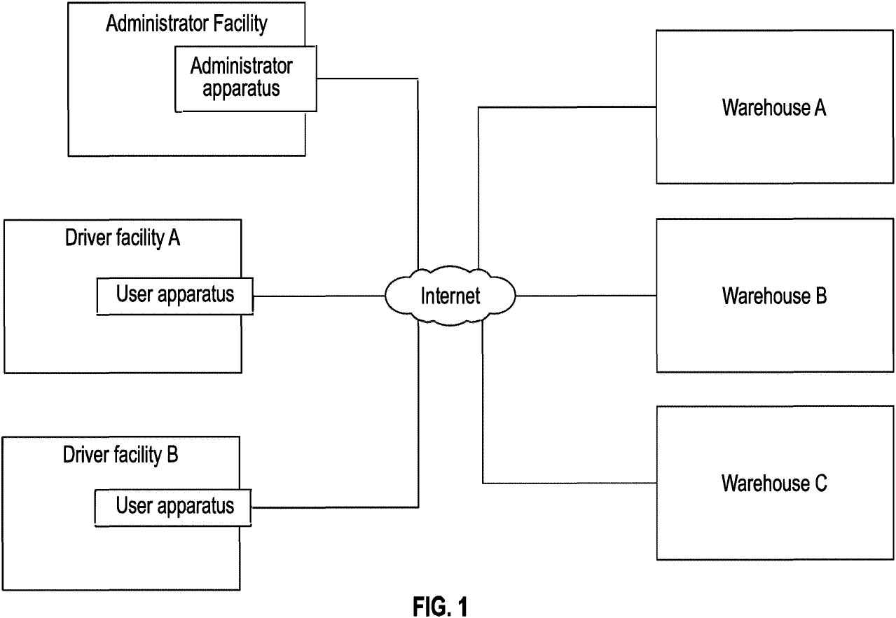

FIG. 1 schematically depicts a freight delivery/pick-up system, according to some embodiments. The overall system includes a driver facility, an administrative facility, and a warehouse. As shown in the example of FIG. 1, there are two driver facilities and three warehouse facilities. There may be more or less of each of these facilities. Each driver facility includes a user apparatus. Administrator facility includes an administrator apparatus. Warehouses include unloading/loading facilities such as loading docks. Driver facility is remotely located from the warehouses. Administrative facility may or may not be separately located from the driver facility. User apparatuses, administrator apparatus, and warehouses are all in communication via the Internet. They may, however, be in communication via other communication networks, e.g., a LAN. Administrator system communicates with the driver/remote user apparatus as well as the loading/unloading facility and coordinates and controls the logistics of the delivery/pick-up. Some or all of this process is automated by the system apparatuses and software as described herein.

According to an embodiment of the present invention, a driver of a freight vehicle, e.g., delivery/pick-up vehicle, positions himself at a location distant, e.g. driver facility A, B, from the loading/unloading facility. Driver approaches and communicates with a user interface of a user apparatus. User apparatus and administrator apparatus then work together to coordinate the arrival of the delivery/pick-up vehicle at the loading/unloading facility, e.g. warehouse A, B, C. In some cases, the user apparatus is located at or near the warehouse facility. In further embodiments, the system may include a logistics support facility to further aid in the coordination of arrival of the delivery/pick-up vehicle at the loading/unloading facility. Logistics support facility may be a warehouse or other storage facility or area configured for storing freight until it is ready to be delivered to a final destination such as a specific designated loading/unloading bay. As shown in FIG. 1, the logistics support facility, i.e., warehouse A, B, and/or C, may be in communication with the administrator apparatus, user apparatus and/or loading/unloading facility via the Internet or other suitable network. It may also be tied into a server for the administrator apparatus, user apparatus and/or loading/unloading facility. The system may also include an off-site certified scale system that is in communication with the administrator apparatus, user apparatus and/or loading/unloading facility via the Internet or other suitable network. The scale system may be located in a convenient location such as proximate to the user apparatus and/or driver facility. Alternatively, it may be located at a more remote location.

The loading/unloading facility of the present disclosure can take many forms. In many instances, the loading/unloading facility will be a warehouse with multiple loading docks for delivery/pick-up vehicles. In other cases, the loading/unloading facility could involve ships, train yards, commercial stores, fields or any other structure where efficient scheduling of multiple delivery/pick-up vehicles is advantageous.

Embodiments of the present invention include a check-in driver facility that is remote from or distant from a loading/unloading facility. Check-in driver facility includes a user apparatus that the driver of a freight vehicle checks into and interfaces with the freight management system described herein. In some cases, the user apparatus is located at the warehouse facility to facilitate driver check-in at the warehouse facility.

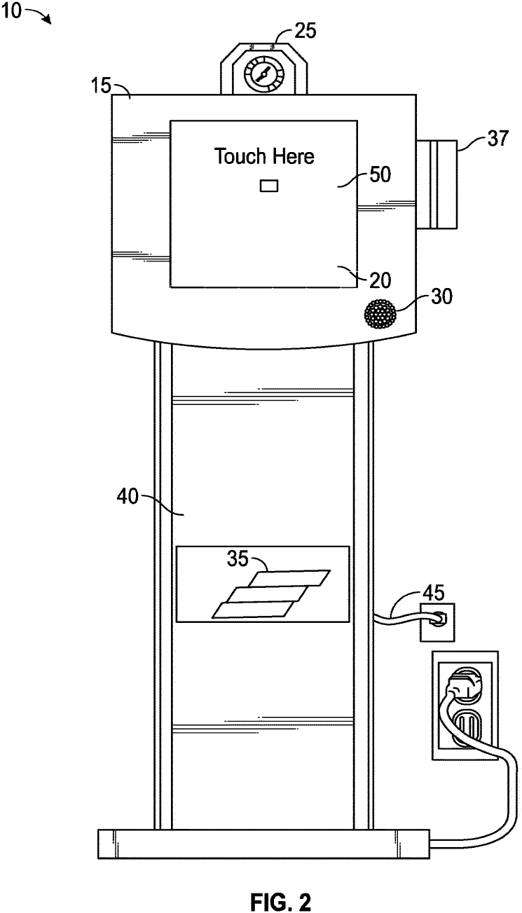

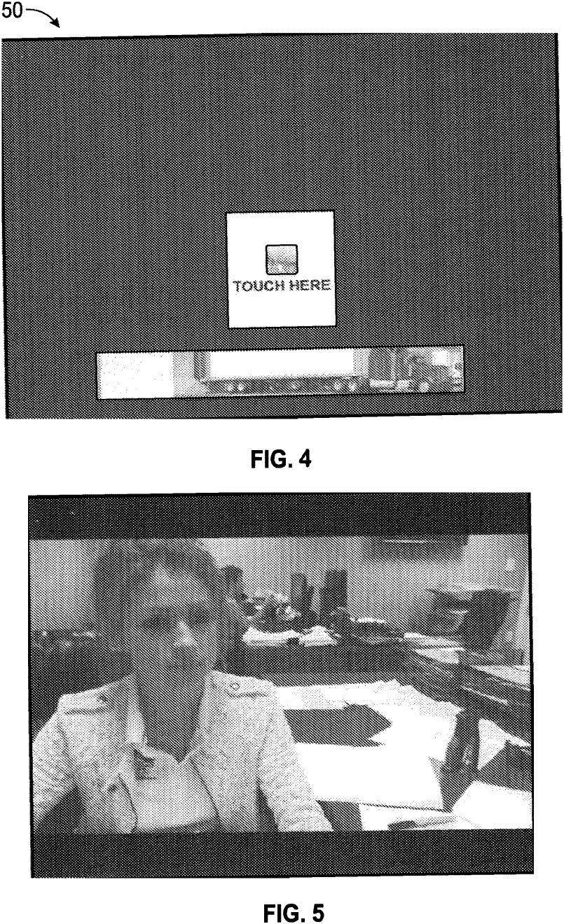

FIG. 2 shows an example embodiment of a user apparatus. User apparatus 10 may be similar in size and shape to a vending machine, or, in other variations, may be configured as a wall mounted display. User interface 50 provides for entry and receipt of freight driver information and may be implemented via one or more of a computer 15, touch screen monitor 20, microphone and speaker 30, a housing, and a stand 40. Touch screen monitor 20 may serve as a communication link between the driver and an administrative system and may incorporate a video display and 2-way communication between the driver and an administrative system. An exemplary user interface screen 50 is shown in FIG. 4. FIG. 5 is a view of a video call as seen from the user interface shown in FIG. 4. User interface 50 is in communication with the administrator apparatus and/or loading/unloading facility and can obtain information from and communicate information to the driver such as check-in time, assigned loading dock, pick-up/drop-off time, authorization information, driver identifying information, truck and trailer number, scale in/weight documentation, authorized driver release, instructions, etc. In embodiments, the user apparatus 10 may be configured to communicate and/or receive this information digitally, visually, audibly, through voice recognition, through scanning devices, or any combination thereof. In one embodiment, the driver simply pushes a single button and is connected to a live administrative representative who instructs the driver what he needs to do and enters information into the system for communication with various components of the system. See, e.g., FIG. 5. In another embodiment, the driver interfaces with an automated administrator apparatus and information may be gathered via voice recognition technologies operable on computer 15 and in communication with the system via a communications network. In some cases, the user interface is initialized based upon a sensor which may be triggered by something other than touching the display, such as, for example, a vehicle sensor, a proximity sensor, an audio sensor, a weight sensor, or some other form of touchless sensor. In some cases, the user interface is touchless and does not require a driver to touch the interface in order to start the check-in or check-out process, or initiate a video or voice call with an administrator.

A computer as used herein, is intended to encompass any suitable processing device. Indeed, the computer may be adapted to execute any operating system including Linux™, UNIX™, Windows™, or any other suitable operating system. In some embodiments, the computer is monolithic with the touch screen. According to some example embodiments, the systems and/or methods described herein may be under the control of one or more processors. The one or more processors may have access to computer-readable storage media (“CRSM”), which may be any available physical media accessible by the processor(s) to execute instruction stored on the CRSM. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other medium which can be used to store the desired information and which can be accessed by the processor(s).

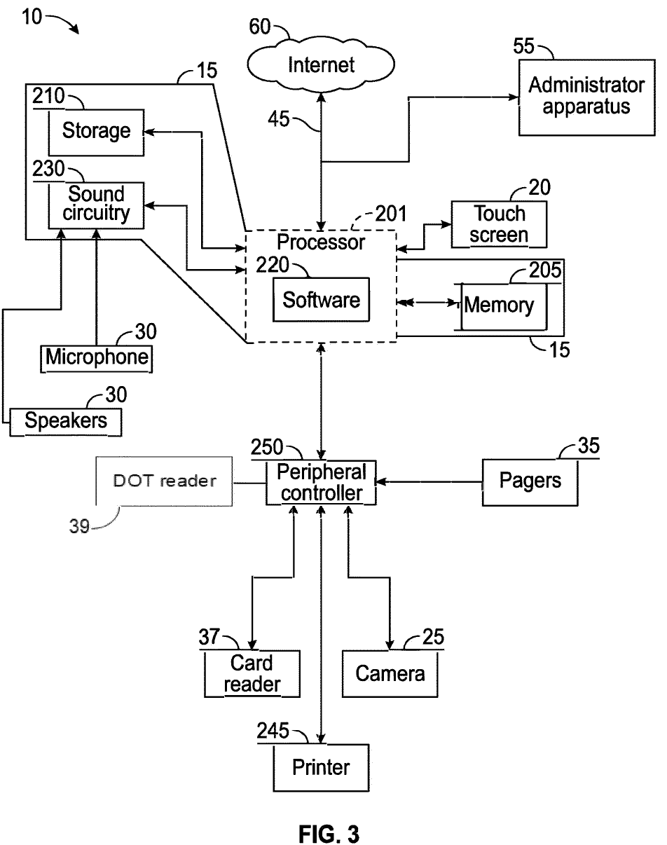

As shown in FIG. 3, the computer 15 may be implemented by a processor 201 running software 220 connected to memory 205, storage 210, and sound circuitry 230. Processor 201 executes instructions, thereby communicating data input from a driver, displaying information sent to the driver, and/or manipulating data. Although described as a single processor, multiple processors may be used according to particular needs. References to processor are meant to include multiple processors where applicable. Memory 205 and storage 210 may include any memory or database module and may take the form of volatile or non-volatile memory including, without limitation, magnetic media, optical media, random access memory (RAM), read-only memory (ROM), removable media, or any other suitable local or remote memory component. Sound circuitry 230 can be any circuit configured to link the processor 201 to the microphone and speaker 30.

Computer 15 implements user interface 50 via software 220. Software 220 may be configured to only have capabilities related to the driver check-in or check-out system. A minimized interface can be desirable to ensure system security, reliability, efficiency, and enhance the driver experience. In various embodiments, the software 220 can include any suitable operating system and may include with a BIOS configured to automatically power and reboot the user apparatus 10 in the event of a power failure. Software 220 can also include messaging functionality and other system software or firmware to communicate with, secure, manage, and update the user apparatus. Status board software can also be implemented. In some variations, the status board may include a text area, and may include, for example, up to 4 lines by 120 characters and in some cases, may present a low resolution dot-matrix interface that may be configured to display or scroll text. Of course, any suitable display may be used, including high resolution display, such as 1080P, 4K, UHD, 8K, or some other high-resolution display.

Referring back to FIG. 2, stand 40 may support user interface 50 and provide for ergonomic interaction with the components of the same. Stand 40 may be used to support computer 15, touch screen monitor 20, and/or microphone and speaker 30. In some embodiments, the stand 40 can be a custom enclosure, while in others, the stand 40 may simply be a table or other suitable apparatus. Stand 40 may have a flat, curved, and/or any other shape suitable to support components of user apparatus 10. For example, in some embodiments, the user apparatus may be mounted and presented in a way where a driver does not need to exit the vehicle in order to interact with the user apparatus. For instance, in a stand-mounted user device, the stand may be configured to present the user device, including the display screen, at a height that facilitates interaction with a driver while seated in the driver’s vehicle. In other cases, the user device may be wall mounted at a height and position that facilitates interaction with a driver while seated in the vehicle. In this way, the driver need not exit the vehicle in order to check-in or check-out of the facility.

User apparatus 10 may be configured with various additional embodiments such as a card reader 37, a networking peripheral 45, a pager holder and/or distributor 35, camera 25, optical scanner and/or DOT (Department of Transportation) reader 39. These features may be linked to user interface 20 via the computer 15 either directly via the computer’s processor 201 or through a peripheral controller 250, e.g. serial or USB controller, depending on the nature of the given attachment. In some embodiments, DOT reader 39 may be installed separate from user apparatus 10 in a location near user apparatus 10. In this embodiment, DOT reader 39 may be either physically or wirelessly connected to user apparatus 10. Apparatus 10 may initiate the operation of the DOT reader 39, which may then work in conjunction with the adjacent user apparatus 10 to verify the identity of the driver. In other embodiments, DOT reader 39 may be installed in a remote/ specifically designated location separate and independently from user apparatus 10. In this embodiment, the DOT reader 39 may be used to verify identity of the driver independently/separately from a user apparatus 10. DOT reader 39 may be configured to obtain a machine-readable DOT number from a (preferably high resolution) image of the side of a vehicle, and upload the DOT number into a driver database. Once in the database, the DOT number may be used to verify the identity of a driver of the vehicle by obtaining matching identification information of the driver, including company information, from the database. The image may be captured using any commercially available camera. DOT reader 39 may be operated via customized algorithms configured to extract the DOT number from the image.

Card reader 37 may be utilized to gather information regarding a driver of a delivery/pick-up vehicle. Card reader 37 may read cards such as payment cards or identity cards. Examples of card readers 37 include manual drag through card readers, motorized card readers, and insertion type push-pull card readers.

User apparatus 10 may include a networking peripheral 45 that connects user apparatus 10 to a remote apparatus, e.g. an administrator apparatus 55 and/or a server 60. Network peripheral 45 may be wired, e.g., via CAT 5 cabling. In other embodiments, a wireless network connection may be provided, e.g., Wi-Fi or cellular. In some cases, multiple connections types are employed, such as for redundancy.

User apparatus 10 may include a pager holder that distributes pager(s) 35. Pagers 35 may also be distributed at another location by an attendant at the driver facility. Pager 35 may be in communication with user apparatus 10, administrator apparatus 55, administrative personnel, driver facility personnel, loading/unloading facility, and/or loading/unloading facility personnel. Pager 35 allows a driver to depart from the user apparatus 10, e.g. in excess of 1 mile, and still wirelessly receive notifications. Pager 35 may also be used to locate a driver. In some instances, pager 35 may be, specifically, in communication with the network peripheral 45 of the user apparatus 10. This configuration can permit a page to come from a distant location. Examples of commercially available pagers include Jtech Inteliflex™.

In some embodiments, pager 35 is connected to computer 15; however, pager 35 may, instead, be connected to a second computer which is a further component of the user apparatus 10. In some cases, a driver provides a phone number to a device associated with the driver. The system may communicate with the driver through the device associated with the driver.

Camera 25 may also be included with user apparatus 10. In some embodiments, camera 25 may be a megapixel facial recognition camera. Camera 25 may allow a driver to engage in video communications with a remote apparatus, e.g. an administrator apparatus 55. Camera 25 may have a field of vision to capture an area adjacent to the driver while the driver is in its field of view. Camera 25 images may be used by software 220 for security, video logging, and facial recognition. Camera 25 images may also be used in conjunction with a DOT reader to extract a DOT number from a camera 25 image obtained from the side of a vehicle. Examples of cameras 25 include commercially available webcams.

Printer 245 may be included with user apparatus 10. Printer 245 may print information as instructed by computer 15. Printer 245 may be, in various embodiments, a laser printer, a label printer, a receipt printer, or otherwise. Software 220 can print information for the driver using printer 245 either a) via the user apparatus 10 or b) from a remote command received, for example, over the network peripheral by an administrator apparatus 55. In some cases, the printer 245 may be configured to print paperwork associated with the delivery or the pickup. For example, in some cases, the printer may print a bill of lading (“BOL”) that may serve as documentation of the load carried by the driver.

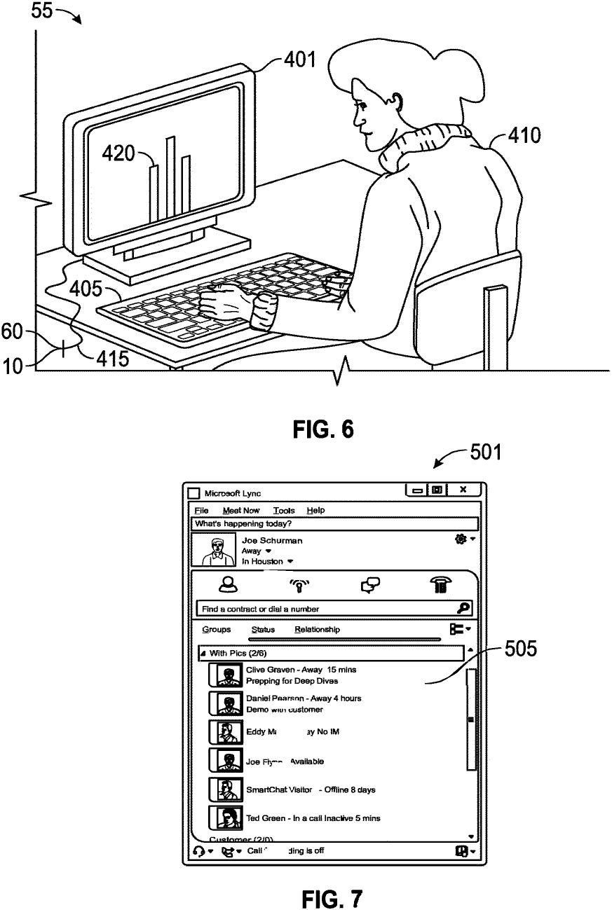

FIG. 6 shows an administrative apparatus 55 according to some embodiments. Administrator system and/or apparatus 55 is shown with administrative personnel 410; however, some or all of it may be automated. Administrative system 55 may communicate with user apparatus 10, a loading/unloading facility 64, and/or the device associated with the driver. Administrative system and/or apparatus 55 may coordinate and control the logistics of a delivery/pick-up. For instance, the administrative system and/or apparatus 55 may deliver a message to the device associated with the driver instructing the driver to proceed to a particular dock, or to wait for a scheduled time, or to confirm that the loading or unloading has been complete and the driver may proceed to leave the warehouse facility.

In some embodiments, implementation of administrator apparatus 55 may include a software driven computer 401 with video call functionality displaying an administrator interface 420, as well as a keyboard 405 for data entry and a network connection 415. Administrator apparatus computer 401 may run a variety of software. In some embodiments, the administrator apparatus computer 401 may run an instant messenger client software and may be configured to send short messaging service (“SMS”) messages to the device associated with the driver.

When no call is incoming to administrator apparatus 55, a window 501 may be displayed on administrator apparatus 55, as shown in FIG. 7, showing the status of the administrator apparatus 55 and available clients to initiate a call 505. Administrator apparatus 55 can also, optionally, view camera 25 of user apparatus 10 to monitor the driver facility when no call is ongoing.

According to certain embodiments, a driver approaches a user apparatus 10 and commences a video call with an administrator apparatus 55. When a call is initiated from user apparatus 10, a popup message plays a ringing sound and displays the name of the location that the call is coming from. The call may be displayed on multiple administrator apparatuses 55. Once an administrator 410 clicks “accept call”, the call notification disappears and the administrator 410 is connected to the driver located at a user interface 10. Driver and administrator 410 may communicate via camera, text and/or speakers. Driver answers questions the administrator 410 has and administrator enters in relevant information, e.g. truck and trailer number, driver identifying information, load identifying information, BOL information, scale in/weight documentation, carrier safety certification, driver mobile communication device number (e.g. mobile telephone number), etc., into administrator apparatus 55. Information received at the user apparatus 10 may be used to ensure the driver and/or load are authorized, and provide relevant instructions to the driver. If there is a problem, e.g., improper load, improper load weight, revoked driver’s license, etc., the driver can be flagged and automatically or manually reported by the system to the appropriate authority. The inputted information may be stored in computer 401 or via the network connection to other system components such as the loading/unloading facility 64 and/or computer 15 of user apparatus 10. In certain embodiments, some or all of the information from a driver is gathered at user interface 50 and automatically sent to administrator apparatus 55 and the driver interfaces with an automated administrative computer system.

Administrative apparatus 55 and/or user apparatus 10 may be in communication with loading/unloading facility 64 and query available docks. Sensors may be provided at each loading/unloading dock of loading/unloading facility 64 and in communication with administrative apparatus 55 and/or user apparatus 10 as to availability. Alternatively, personnel at loading/unloading facility 64 may be in communication with administrator apparatuses 55 and/or administrators 410. If an available dock is located, information may be displayed to administrator 410 at administrator apparatus 55 and/or forwarded to the user apparatus 10 and/or provided via phone call. A phone call may be made to the user apparatus 10 or to a communication device associated with the driver. In some cases, the information may alternatively or additionally be sent to the device associated with the driver. Administrator 410 may then, through the video connection or other communication devices, communicate with the user apparatus 10 and instruct the driver to proceed to the appropriate loading dock.

If an available loading dock cannot be located, the driver may be assigned by the administrative apparatus 55 and/or user apparatus 10 a pager, or may have additional communications sent to the device associated with the driver (e.g., cell phone). An appointment for the driver may then be scheduled by the system. Once an available loading dock is located, the assigned pager 35 or device associated with the driver is messaged, e.g. by the administrator 410 and/or user apparatus 10. The driver may then optionally initiate a new call at the user apparatus 10. Once connected to an administrator 410, the driver may be directed to the available dock. In additional exemplary embodiments, the administrative apparatus 55 can display a queue at the user apparatus 10 and/or directly instruct the driver to an available dock without the use of an administrator 410.

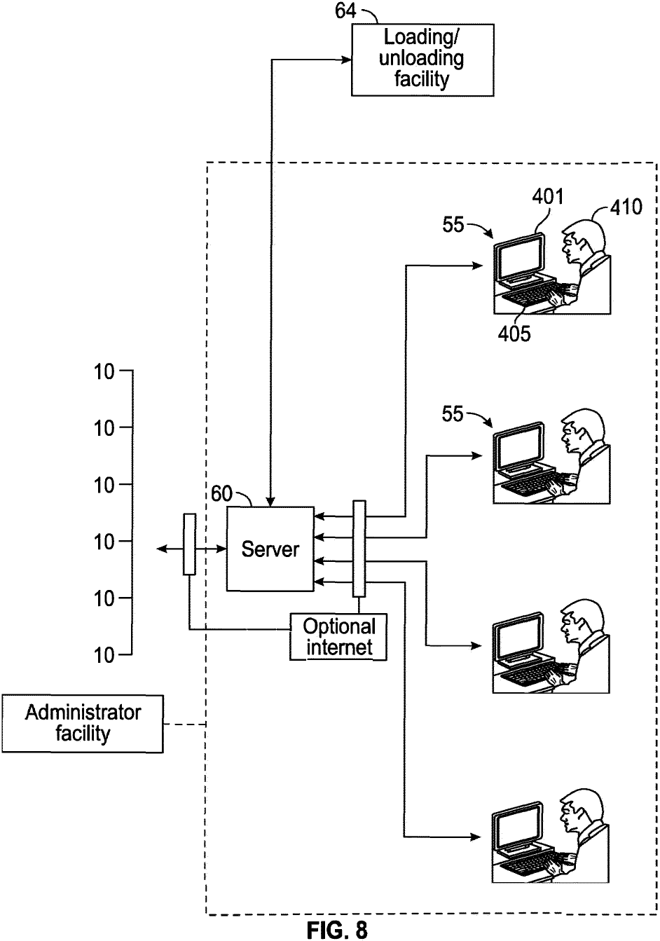

Embodiments of the present invention provide for utilization of multiple user apparatuses 10 and/or multiple administrator apparatuses 55. As shown in FIG. 8, six user apparatuses 10 are connected to the Internet and communicate with server 60. Four administrator apparatuses 55 are connected to the Internet and in communication with server 60. Additionally loading/unloading facility 64 is connected to the Internet and in communication with server 60. In embodiments of the present invention, other suitable networks may be used with or without a server 60.

Server 60 may be used to facilitate communications between user apparatuses 10, administrator apparatuses 55, loading/unloading facility 64, and/or other components of the system as described herein. The use of a server 60 can diminish the computing requirements of the user apparatus 10 and administrative apparatus 55. Server 60 can be in various embodiments either a physical server, or a server hosted through the internet, such as a cloud-based server or a distributed server model.

Server 60 may serve to further aid in the coordination of delivery/pick-up arrival at a loading/unloading facility 64 by automating elements of the system. Examples of the interaction of server 60, user apparatuses 10, administrator apparatuses 55 and/or loading/unloading facility 64 can be seen in FIG. 8.

According to some embodiments, a driver is advised to check in at a user apparatus 10 located remotely from loading/unloading facility 64 at an off-site location, such as a drivers lounge. The driver upon arrival touches the touch screen 20 of the user apparatus 10 and initiates a video call to the server 60. Server 60 rings multiple administrative apparatuses 55, and after an administrator 410 at an administrator apparatus 55 accepts the call, the server 60 connects the call and stops the ringing. Administrator 410 then inputs relevant information, such as trailer and truck number, drivers phone number, etc., into the server 60 using the administrator apparatus 55.

Server 60 is in communication with loading/unloading facility 64 and queries a warehouse database and/or loading/unloading facility 64 personnel to attempt to locate an available dock. Sensors may be provided at each loading/unloading dock of loading/unloading facility 64 and in communication with server 60 as to availability. Alternatively, personnel at loading/unloading facility 64 may be in communication with server 60, administrator apparatuses 55 and/or administrators 410. If server 60 is communicated to and is able to locate an available dock, the available dock information is displayed to administrator 410 at administrator apparatus 55. Administrator 410 then through the video connection or other communication devices communicates with the user apparatus 10 and/or the device associated with the driver and instructs the driver to proceed to the appropriate loading dock.

If the server 60 is unable to locate an available loading dock, the driver may be assigned by the server 60 a pager from the user apparatus 10. Once the server 60 locates an available loading dock, the server 60 messages the assigned pager 35 or the device associated with the driver. The driver may then initiate a new call at the user apparatus 10. Once connected to an administrator 410, the driver can be directed to the available dock. In additional exemplary embodiments, the server 60 ^{can} display a queue at the user apparatus 10. The various embodiments described herein may also be implemented without a server 60.

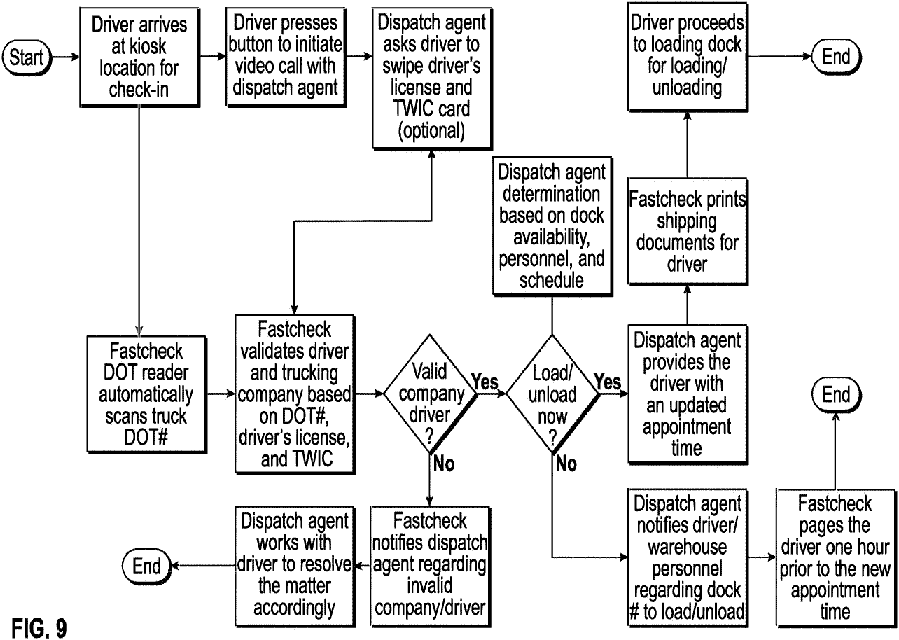

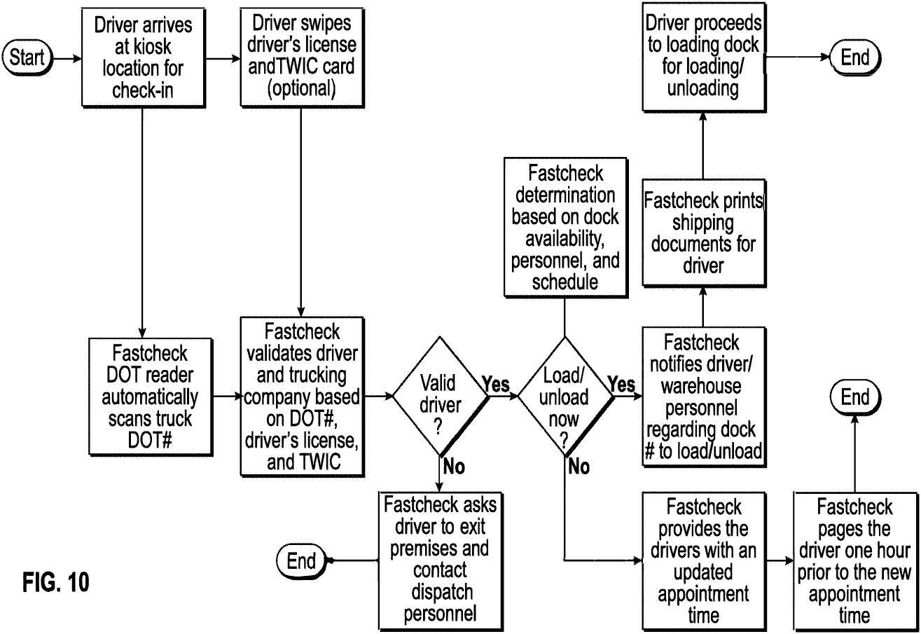

FIG. 9 shows a freight delivery/pick-up system using a dispatch agent, according to some embodiments. FIG. 10 shows an automated freight delivery/pick-up system, according to some embodiments. The systems described in FIGS. 9 and 10 may be implemented using the apparatuses, systems and methods described herein, including various embodiments thereof.

Referring to FIG. 9, a freight delivery/pick-up system may include one or more of the following steps. A driver/user arrives at a location of a user apparatus/kiosk 10 for check-in. The user apparatus initiates a call with a dispatch agent, which may be done by pressing a button to initiate the call or may be done by a touchless trigger, such as a sensor. The call may be a video or audio call or both. The dispatch agent may ask the driver/user to verify his mobile phone number, swipe his/her driver’s license, TWIC (Transportation Worker Identification Credential) card, and/or other form of similar identification. In other embodiments, a DOT reader on the user apparatus/kiosk 10 may automatically scan a related truck DOT number to get this information. Alternatively, DOT reader may be located separately and/or independently from user apparatus 10. The system then validates the driver/user and his/her trucking company based on the driver’s license, TWIC card, and/or DOT#, and determines whether the user/driver is a valid company driver. If not valid, the system notifies the dispatch agent regarding the invalid user/driver and/or company. The dispatch agent may work with the user/driver to resolve the matter accordingly. If a valid driver, the dispatch agent can determine whether the driver/user may perform loading/unloading at this time based on dock availability, warehouse personnel, and schedule. If no dock is available, the dispatch agent provides the driver/user with an appropriate appointment time, and then pages the driver/user an hour prior to the new appointment time. If a dock is available, the dispatch agent notifies the driver/user and warehouse personnel regarding the particular dock and/or dock number to perform the loading/unloading. The system is then used to print relevant documents, including shipping documents, for the driver/user to take to the dock. The driver/user then proceeds to the dock for loading/unloading.

Referring to FIG. 10, an automated freight delivery/pick-up system is described. This automated system may provide for the same steps as disclosed herein for systems using a dispatch agent, however, the system may be fully automated such that a dispatch agent is not required. Alternatively, a system may be provided that is partially automated and uses a dispatch agent as needed.

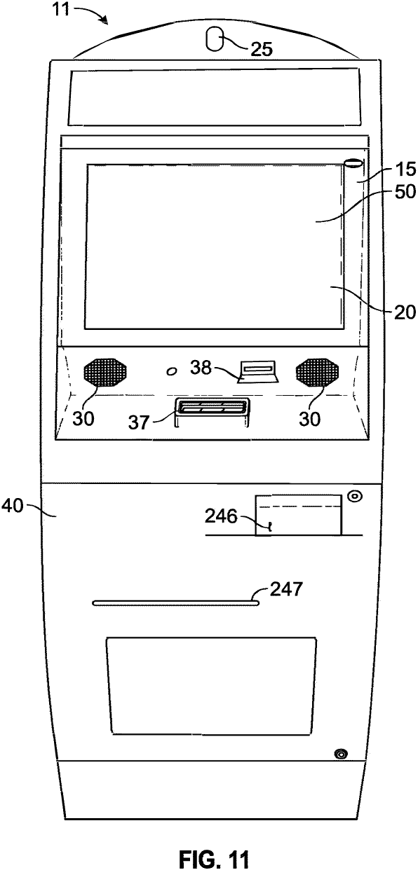

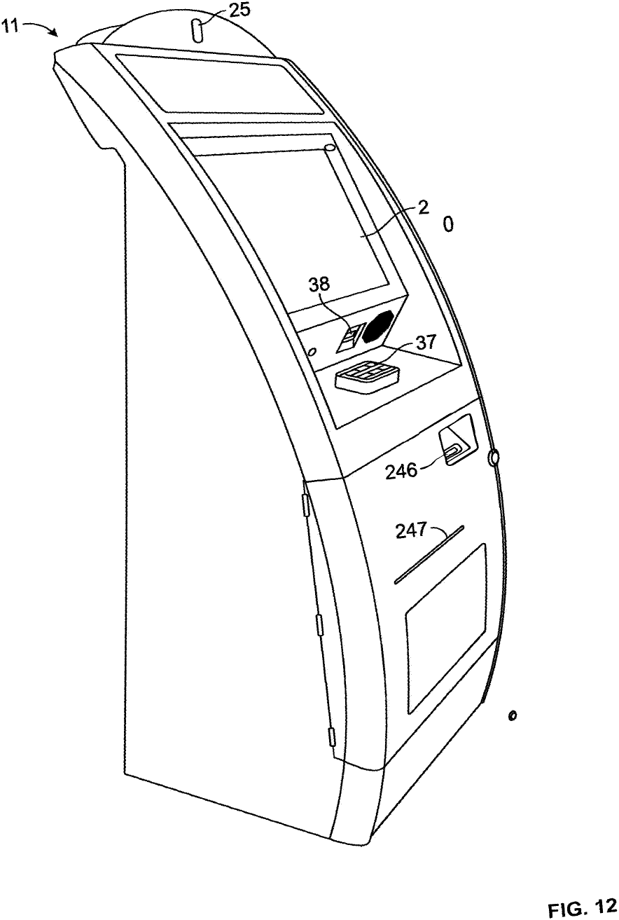

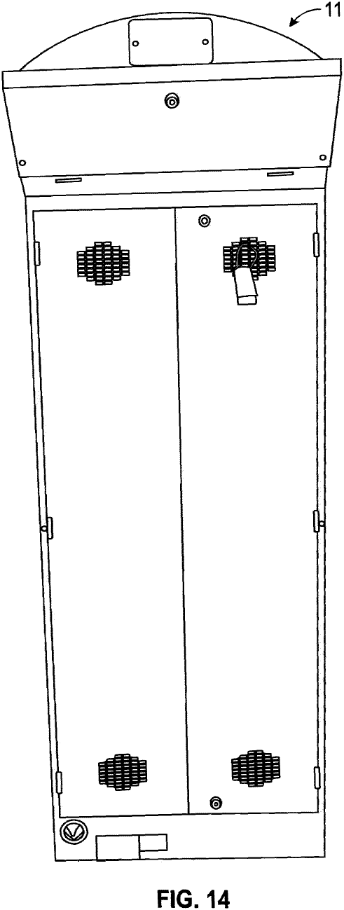

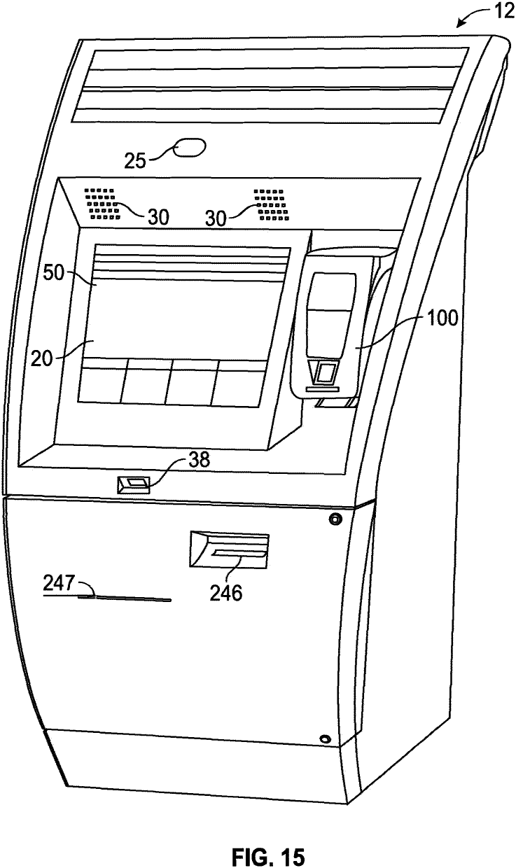

FIGS. 11 to 14 show different views of a user apparatus 11. FIG. 15 shows another example user apparatus 12. User apparatuses 11, 12 represent different embodiments of user apparatus 10. The user apparatuses 11, 12 may have substantially the same features as user apparatus 10, including but not limited to user interface 50, computer 15, touch screen monitor 20, microphone and speaker 30, stand 40, and camera 25, but may include additional features/modifications. User apparatuses 11, 12 may be implemented, as appropriate, in place of or in addition to user apparatus 10 as described herein.

In some cases, user apparatuses 11, 12 may have a substantially curved front portion designed to provide a sleeker profile. See FIGS. 12 and 15. Alternatively, both apparatuses 11, 12 may have a flat, rounded, and/or any other shape necessary to perform their functions.

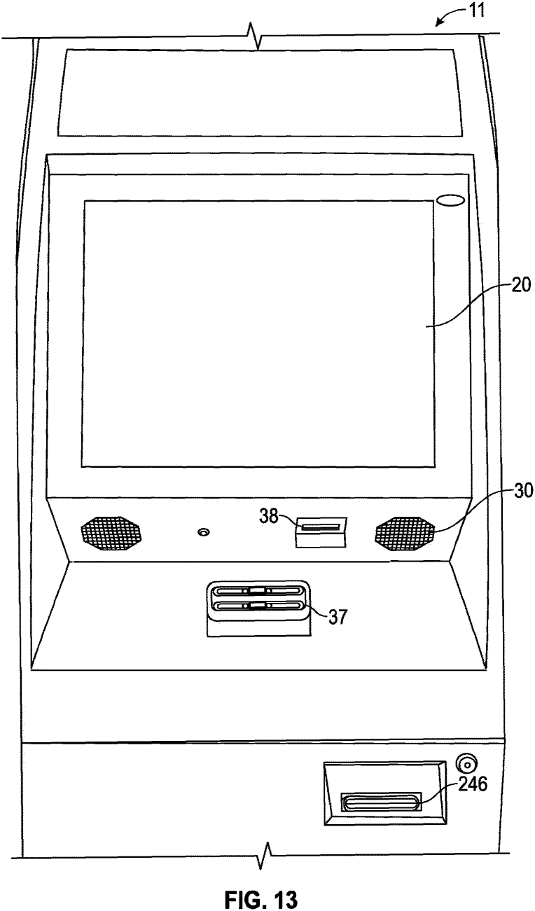

User apparatuses 11, 12 may include a slot for a printer 246 located on the front of the apparatuses 11, 12. See FIGS. 13 and 15. As shown, printer 246 may allow users to print adhesive badge labels that affix to plastic badges. Printer 246 may also print non-adhesive badges. Badge labels may include identifying information of a driver/user, including driver name, title, company name, and/or any other relevant information. Printer 246 may be located either within user apparatuses 11, 12 or located adjacent to apparatuses 11, 12. Printer 246 may also print documentation associated with a load, such as a receipt, a BOL, or other type of documentation.

User apparatuses 11, 12 may further include a slot for a printer configured to print on 8 ½”× 11” paper (“8 ½ × 11 printer”) 247 located on the front of the apparatuses 11, 12. See FIGS. 11 and 15. As shown, 8 ½ × 11 printer 247 allows drivers/users to print a variety of documents, including shipping and freight delivery documents such as a bill of lading. Bill of lading documents shipments/cargo while giving title to a specified party (e.g. delivery warehouse operator). 8 ½ × 11 printer 247 may be located either within user apparatuses 11, 12 or located adjacent to apparatuses 11, 12.

User apparatuses 11, 12 may include a barcode scanner 38 located on the front of the apparatuses 11, 12. See FIGS. 13 and 15. Barcode scanner 38 may be configured to read 1D or 2D barcodes. As shown, barcode scanner 38 may have a clear rectangular face that scans a barcode, for e.g., 2D barcode of a driver’s license, placed in front of scanner 38. Scanner 38 may then pull information from the driver’s license and display the information on the user interface 50. Alternatively, barcode scanner 38 may have any other configuration to scan barcodes.

Like user apparatus 10, user apparatus 11 may include a card reader 37 having the same features disclosed herein. As shown in FIG. 11, card reader 37 in user apparatus 11 is installed on the front of the apparatus 11. However, card reader 37 may be placed on any other location on the user apparatus 11. Card reader 37 may be a magnetic stripe / magstripe reader configured to read information encoded in the magnetic stripe located on the back of a plastic badge and/or other documents containing identifying information. For example, card reader 37 may read magnetic strips of credit cards or driver’s licenses, and may also be configured to read passports.

In other embodiments, user apparatus 12 may be implemented in place of or in conjunction with user apparatus 10 and/or user apparatus 11 in various embodiments of the present invention described herein. User apparatus 12 may include a reader 100 for reading a TWIC card and configured to act as a separate identification mechanism for user/driver. As shown in FIG. 15, reader 100 may be installed on the front of the apparatus 12. However, reader 100 may be placed on any other location on the user apparatus 12. A kiosk apparatus having a TWIC card reader for reading a passenger’s TWIC card is disclosed in U.S. Pub. No. 2013/0226632, which is incorporated herein by reference. A TWIC card may be read in different ways. First, TWIC card may contain a passive RFID chip that contains information (including fingerprint information) about the TWIC card and driver/user. Reader 100 may be an RFID reader configured to pull this information/data via a wireless Near Field Communication (NFC) connection. Second, reader 100 may be a contact-based smart card reader which, like the RFID based chip, contains information about the TWIC card and driver/user. Reader 100 can validate and authenticate the TWIC card and verify the identity of a driver using the card at any designated access control points, ensuring that only those who are intended to have privileged access are able to enter secure facilities.

As shown, reader 100 may be a biometric (fingerprint) access control reader and/or fingerprint scanner used in conjunction with the user/driver’s TWIC card. Particularly, a TWIC card may contain an image of the user/driver’s fingerprint that will be matched against his or her fingerprint scanned during check-in. Reader 100 may have a wireless NFC connection located on the top of reader 100, and a slot at the bottom of the reader 100 to physically insert the TWIC card. Reader 100 may further provide for an additional PIN authentication mechanism by including a keypad configured so that user/driver may enter a PIN matched to his/her TWIC card. In some embodiments, user apparatus 12 may further include a TWIC smart card reader with video and/or audio capture. Thus, reader 100 may be customized to include single or multiple factor authentication mechanisms as needed. Single authentication factors include fingerprint, pin, or card, while multi-factor authentications combine three or four credential authenticators enabling more stringent security access controls where it is required.

In some cases, readers are designed to perform fast and accurate biometric and credential authentication, and can interface with most physical access control systems and support most government issued credentials. 3M readers can also easily facilitate third party integration.

User apparatuses 11 and 12 may further include a DOT reader. DOT reader may include all the same features as disclosed herein for apparatus 10. DOT reader may be configured to obtain a machine-readable DOT number from a (preferably high resolution) image of the side of a vehicle, and upload the DOT number into a driver database. Once in the database, the DOT number can be used to verify the identity of a driver of the vehicle by obtaining matching identification information of the driver, including company information, from the database. As disclosed herein, DOT reader may be installed on apparatuses 11, 12, at a location adjacent to and/or (physically or wirelessly) connected to apparatuses 11, 12, or may be installed separately/independently from apparatuses 11, 12 at remote/specifically designated locations to function as a separate identity verification system from apparatuses 11, 12.

In some embodiments, user apparatus 12 may include a VoIP (Voice over IP) intercom system for the delivery of audio and multimedia sessions over IP networks, including the Internet.

User apparatuses 11, 12 may be configured and/or customizable to any other type of scanners, readers, printers, and/or any other features and components of user apparatuses 10, 11, 12 disclosed herein.

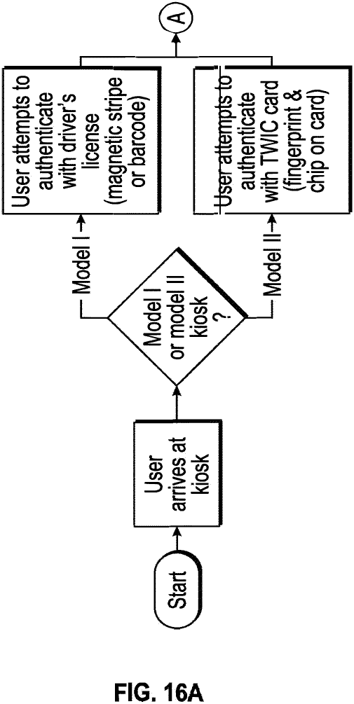

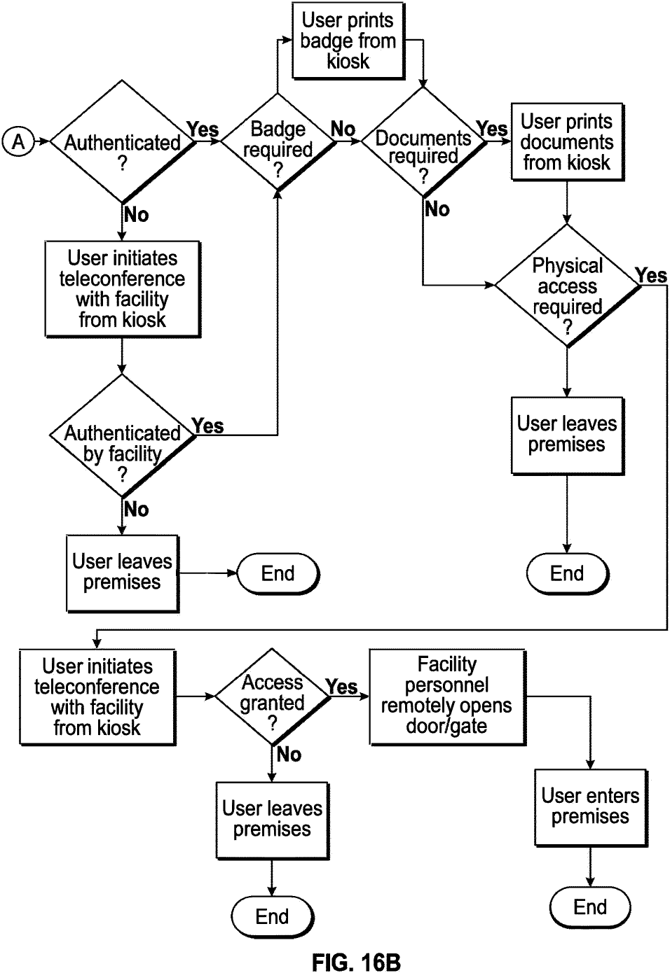

FIGS. 16A and 16B are flow charts showing an automated freight delivery/pick-up system using any of the user apparatuses disclosed herein or their variants. The system described in FIGS. 16A and 16B may be implemented using the apparatuses, systems and methods described herein, including various embodiments thereof.

The system using the user apparatuses 11, 12 may include the following steps. A driver/user arrives at a location of a user apparatus 11, 12 for check-in. The driver/user may attempt to authenticate his/her identification information with his/her driver’s license and/or other similar identification via the card reader (magnetic stripe) 37 or barcode scanner (barcode) 38. In some cases, the driver/user attempts authentication with his/her TWIC card via the TWIC card reader (fingerprint and chip on card) 100. The system then authenticates the driver/user and his/her trucking company based on the driver’s identifying information and determines whether the user/driver is a valid company driver. In some embodiments, DOT reader located on the apparatuses 11, 12 or in a separate location from apparatuses 11, 12 may obtain and use a DOT number on the driver’s vehicle to verify the driver’s identifying information. If not valid, the driver/user initiates a call with a facility using the apparatus 11, 12. The call may be a teleconference or multimedia call. The facility then makes an additional determination as to whether the driver/user’s information can be authenticated. If not, the driver/user leaves the premises.

If the driver/user’s information can be authenticated, or if the user/driver was initially determined to be a valid driver, the user/driver may print a badge and/or any other documents, including shipping documents, using the user apparatus 11, 12. User/driver may print a badge using the badge printer 246 on the apparatus 11, 12. User/driver may also print additional documents using the 8 ½ by 11 printer 247 on the apparatus 11, 12. If user/driver does not need a badge and/or additional documents, and requires physical access into the facility, the user/driver may initiate a call with the facility using the apparatus 11, 12. The call may be a teleconference or multimedia call. If access is not granted, user/driver leaves the premises. If access is granted, facility personnel remotely (or physically) open doors/gates to the facility, and user/driver enters the facility.

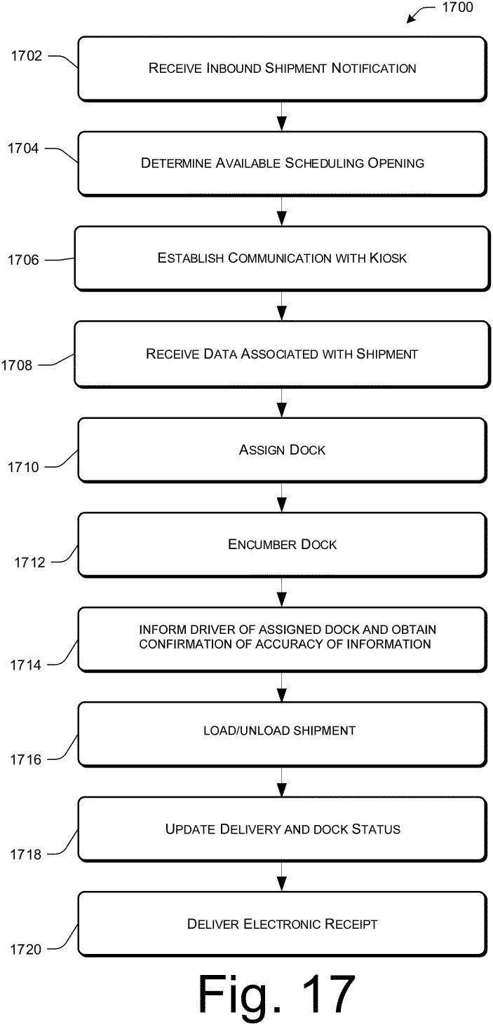

A discussion of the process that occurs when a driver arrives at a warehouse to deliver goods or to pick up goods will be provided below with references to FIG. 17-21B. However, before that would occur it is first necessary for a delivery or pick up to have been scheduled. The process of setting up a scheduled delivery is first discussed below. Following that, we will turn to a discussion of what occurs when a driver arrives at a warehouse facility to accomplish a scheduled delivery or pick up.

When a driver or an agent for a driver, such as a carrier or broker, receives a delivery or pick-up assignment from a customer, the driver or the driver’s agent contacts the scheduling system to schedule the delivery or pick up. With reference to FIG. 8, that contact could be in the form of a call to or an email message sent to administrative personnel 410 to request an appointment time for delivering or picking up a load from loading/unloading facility 64.

Administrative personnel 410 would then interact with the driver or the driver’s agent, via a telephone call, a video call or via electronic messaging to obtain certain items of information about the shipment. That information can include the name of the driver and/or the driver’s agent (carrier/broker), the name of the customer who is having the shipment performed, a bill of lading (BOL) number, and whether the scheduled event is to be a delivery or a pickup. The information can include a variety of information about the shipment, such as the size, weight and the way in which the shipment will be packaged. The information could further include details about what sort of loading/unloading equipment will be required to load/unload the shipment. If a delivery is being scheduled, the information could include the shipment origin (city/state). If a pick up is being scheduled, the information could include the shipment destination for all planned delivery stops.

Additional information acquired by the administrative personnel 410 may include contact information for the individual requesting the appointment and contact information for the driver. Such contact information could include a telephone number, and email address or some other form of identifier used to send and receive electronic communications.

The driver or driver’s agent could request a certain date/time for the scheduled delivery/pick up. The administrative personnel 410 may then use a scheduling application displayed on user administrator interface 420 to input the information provided by the driver or the driver’s agent. The administrative personnel then uses the scheduling application to identify one or more appointment times for the delivery/pick up. The scheduling application may include configurations that allow appointment slots to be categorized by type of shipment, equipment required, anticipated length of appointment times. If possible, the administrative personnel 410 will setup the appointment for the delivery/pick up at the time requested by the driver or driver’s agent. If this is not possible, the administrative personnel 410 may identify one or multiple alternate appointment times and allow the driver or driver’s agent to select an appointment time from the available slots. And the end of the process, the administrative personnel informs the driver or driver’s agent of the established appointment time. The selected appointment time may then be communicated to the warehouse at which the delivery/pick up will occur.

FIG. 17 illustrates a process flow according to some embodiments for a check-in at a warehouse facility 1700. The techniques disclosed herein are equally applicable to situations where a driver is delivering a shipment of goods to a warehouse and situations where a driver is arriving at a warehouse to pick up a shipment of goods. Thus, the following description is intended to cover both scenarios.

At block 1702 a system like to ones illustrated in FIGS. 3 and 8 may receive an inbound shipment notification. For example, the system may receive information that includes details of a shipment. The details may include the carrier, an identification of the cargo, an originating location of the shipment, the destination of the shipment, the date/time that the shipment has left or is scheduled to leave the originating facility, an expected date/time of arrival at the destination, the name of the driver, an identification of the truck or trailer that will be transporting the cargo, or other information that may be useful by the system in facilitating the appointment scheduling and delivery or pick-up of the shipment.

At block 1704, the system determines an available scheduling opening for delivery or pick up at a warehouse. This may be performed as described elsewhere herein and may include the system querying a schedule of a warehouse facility to determine when a warehouse may be available to receive a shipment of goods or when the warehouse is available to load goods onto a carrier. This may further include identifying an opening during which a particular dock is available for loading/unloading, a schedule of warehouse operators and/or loading/unloading personnel, a schedule indicating availability of warehouse loading/unloading equipment, along with other information. The inbound shipment notification may be received over an electronic document interchange (“EDI”) such as from a first computer to a second computer over a network such as the Internet. In some cases, the inbound shipment notification may be sent as a file and entered into the system, either automatically, manually, or a combination.

The delivery or pick-up can be scheduled with the receiving/loading warehouse, such as through a scheduling system. In some cases, the scheduling system can automatically schedule the delivery/pick up at the warehouse. For instance, the system may have access to a scheduling system associated with the warehouse and may determine an available dock that coincides with the anticipated arrival date/time of the conveyance vehicle and that satisfies other parameters, such as location of dock relative to goods storage locations, availability of warehouse personnel and equipment, and the like. The delivery or pick-up scheduling may also take into account the availability of loading/unloading personnel and the availability of equipment at the warehouse required to accomplish loading/unloading.

The system may be updated with the scheduled delivery or pick-up, which may be performed automatically, manually, or a combination. The system may further be in communication with a scheduling system associated with the warehouse, or with an operator of the warehouse. The system may create scheduling entries into the scheduling system associated with the warehouse in order to schedule a delivery or pick-up appointment.

At block 1706, a delivery driver arrives at a facility that includes a kiosk or user apparatus. For purposes of the following discussion, the device used by the driver will be referred to as a “kiosk.” That term is intended to cover any sort of device that enables the driver to communicate with an administrator. The facility at which the kiosk is located may be a warehouse where a delivery or pickup is to occur, or at a facility remote from the warehouse, such as a driver lounge or truck stop located apart from the warehouse.

Upon arrival at the kiosk, the driver establishes communications with an administrator. The communication may be via a voice call, a video call, text messages or other electronic communications, or a combination of these communications means. In some cases, a voice or video call is initiated by the driver by pressing a button, such as a displayed button on a touch screen display of a kiosk. In other cases, one or more sensors may determine that a truck has arrived at the kiosk and the call may be initiated in response to sensor data. The kiosk may include a display approximately at the driver’s eye level such that the driver is not required to exit the vehicle in order to interact with the display.

At block 1708, the administrator communicates with the driver to collect various items of information. This can include obtaining or verifying the driver’s identity, the truck identity, and information about the shipment. For example, the administrator may communicate with the driver to obtain a pickup number, a delivery number, the driver’s name, a driver’s mobile telephone number, a driver’s email address or some other form of electronic communication address or username, a truck number, a trailer number, a DOT number, etc. In some cases, the questions and/or answers may be displayed on the kiosk display. This allows the driver to view and verify the information the administrator is collecting.

To enable the administrator and the driver to communicate via electronic messaging, the driver may provide the administrator with a telephone number associated with the driver’s smartphone. This would enable the administrator and the driver to exchange SMS or MMS messages. However, this is but one way of enabling the administrator and the driver to communicate via electronic messaging.

In other instances the driver could provide the administrator with a telephone number that is associated with a telephony software application on a driver’s smartphone, laptop, tablet or some other form of mobile computing device. The telephone number associated with the telephony software application could be used much like a traditional telephone number in order to send and receive SMS and MMS messages.

In still other instances, the driver could provide the administrator with an alternate identifier that is used in connection with an electronic messaging service. The alternate identifier also could resemble a telephone number, or the alternate identifier could take on other forms. Use of the alternate identifier would also allow the administrator and the driver to exchange electronic messages that pass over the Internet or over a telecommunications or cellular system.

In yet other embodiments, the driver could provide the administrator with an email address or another form of messaging address that will allow the administrator and the driver to exchange other forms of electronic communications, such as email messages. Such messages could be sent and received by the driver on a smartphone, a tablet computing device, a laptop computer or some other type of mobile computing device.

Regardless of the type of electronic messages that are exchanged between the administrator and the driver, the use of electronic messaging allows the driver to send and receive messages without exiting the delivery vehicle and without engaging in face-to-face communications with an administrator or personnel associated with warehouse facility where the delivery or pick-up will occur.

In some cases, the administrator may be located remote from the kiosk and may manage multiple kiosks. Typically, there are a greater number of kiosks than there are administrators, which allows a small team of administrators at a first location to monitor and interact with drivers at a plurality of kiosks that may be geographically spread out.

The administrator may review the dock schedule at the warehouse to which the driver is headed for a delivery or pick-up and determine which dock the driver should be sent to. At block 1710, the driver is assigned to a dock. The dock assignment may be entered by the administrator into the system and may update the status in the scheduling system to reflect that the driver has arrived at the kiosk. At block 1712, the dock within the scheduling system is encumbered to show the dock as busy or otherwise unavailable for receiving or sending goods.

At block 1714, the administrator may verbally tell the driver which dock has been assigned and provide instructions for reaching the assigned dock. The dock assignment may be displayed on the display screen of the kiosk along with other pertinent information or instructions. Optionally, an electronic communication that includes the dock assignment is sent to the driver. Such an electronic communication could be sent to a mobile computing device associated with the driver, such as to the driver’s cellphone, smartphone, tablet computer, laptop or other mobile computing device.

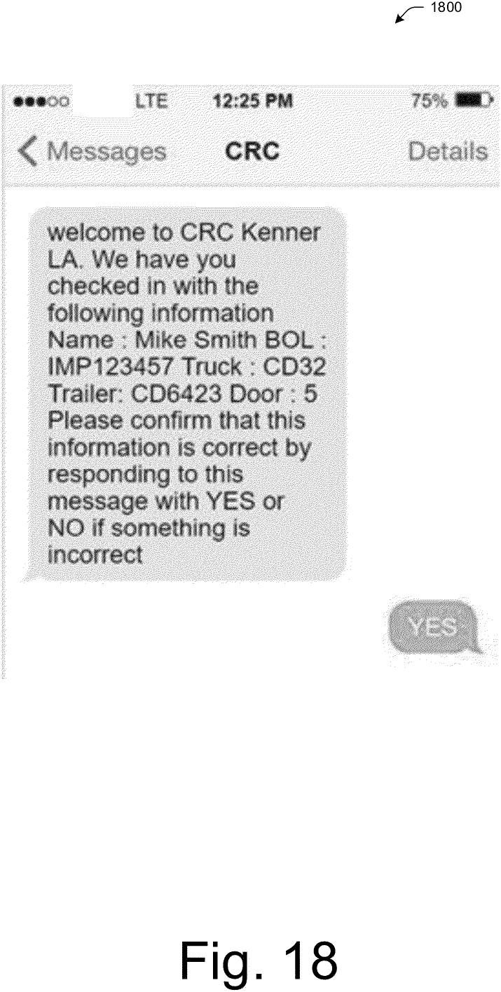

A sample of such an electronic communication is shown at FIG. 18. As noted above, the electronic communication 1800 may be sent as an SMS message, an MMS message, an email message or via an alternate electronic messaging protocol or method.

The electronic message may include both information identifying the loading dock that has been assigned and information that helps the driver to locate the loading dock. Such additional information could include driving directions and/or a map marked with the location of the loading dock. The electronic communication may also include a link that the driver could select or follow to obtain a map or driving directions that help the driver to locate the assigned loading dock.

The electronic message 1800 set to the driver may prompt the driver to confirm the information that the administrator has collected and entered into the system. In that case, the electronic message will include the information that the administrator wishes to confirm. A response message of “YES” sent from the driver to the administrator can be recorded and serve as the verification record of the inbound sheet. A negative response message from the driver may prompt the administrator to further communicate with the driver, such as through the kiosk or via additional electronic communications, to correct any information and resend the electronic communication requesting driver confirmation.

In some embodiments, the electronic communications may be routed through a third-party electronic messaging system. For example, the administrator may utilize an application programming interface (“API”) to access an electronic messaging service provided by a third-party. Electronic messages delivered through the third-party messaging service could still be delivered to the driver’s smartphone, tablet computing device, laptop computer or other mobile computing device via the Internet or via a telecommunications or cellular system. For example, the administrator’s system may send an API call to a SMS messaging server with the relevant data, and the SMS messaging server may format and send an electronic message, such as an SMS message, to a mobile computing device associated with the driver.

At block 1716, the driver may proceed to the assigned loading dock to either unload a delivery or pick up goods that are to be delivered elsewhere. Concurrently, or at least after successful confirmation of the driver information at the kiosk, a warehouse worker, such as a warehouse supervisor, may receive a communication with a notification that the driver has been checked in and will be arriving at the assigned dock. The communication to the warehouse worker may be electronic, such as to a mobile computing device (e.g., cell phone, smartphone, a tablet computer, etc.), or may be made by a phone call, an instant message, a call over a loudspeaker, a textual notification on a display board, or some other type of notification.

Also at block 1716, the warehouse personnel may be directed to the assigned dock with the appropriate equipment to load/unload the shipment. The goods are then loaded/unloaded from the driver’s vehicle.

Once the shipment has been loaded/unloaded, at block 1718 the inbound receipt may be closed out in the scheduling system. Also, the status of the loading dock is changed from “unloading” to “complete” to thereby unencumber the dock so that it is available for a subsequent inbound or outbound shipment. These actions may be performed electronically, such as by an API call from the scheduling system to the warehouse management system (“WMS”).

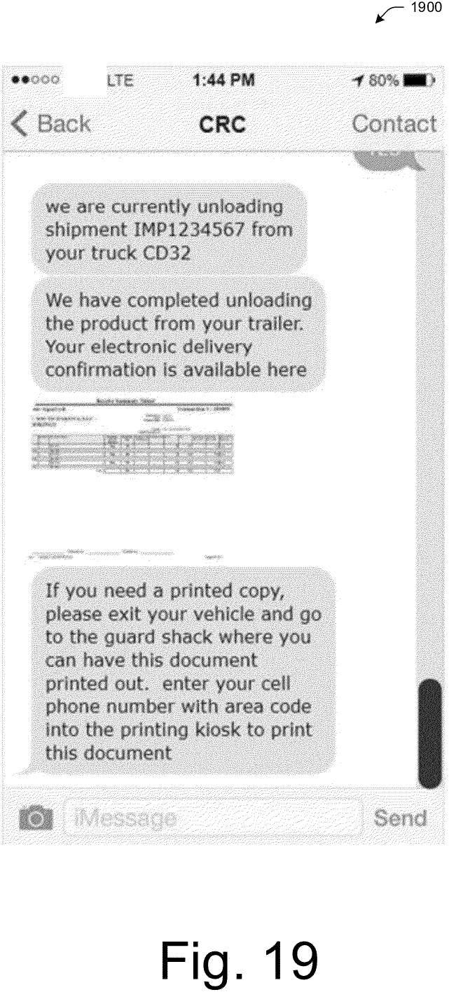

At block 1720, an electronic message 1900 (FIG. 19) may be sent to the driver. If the driver was delivering a shipment of goods, the electronic message may include an electronic delivery receipt or proof of delivery (“POD”). The electronic message may further include instructions for obtaining a printed receipt. In some cases, the printed receipt may be made available at a kiosk as the driver checks-out of the warehouse facility. In some cases, a dedicated check-out kiosk may be provided to facilitate drivers leaving a warehouse facility and obtaining printed documents without having to exit the vehicle.

When a driver is picking up a shipment, it is generally necessary for the driver to receive a bill of lading (BOL). In some cases, the BOL is scanned into the scheduling system, such as by a scanner, by taking a photograph, and/or by conducting an optical character recognition (“OCR”) process to obtain the text of a physical document. The BOL is typically signed by the driver upon pickup of the shipment.

When the driver completes delivery of the shipment to a warehouse, the BOL may be countersigned by warehouse personnel to indicate completed delivery of the shipment. The countersigned BOL may then be provided to the driver as a proof of delivery and/or acceptance of delivery by the warehouse. Historically, a proof of delivery document is printed by warehouse personnel and placed in the back of the unloaded trailer. This is inefficient and can lead to missing documents.

The systems and processes described herein provide an electronic means for handling the BOL and the proof of delivery documents, allowing the documents to be signed and countersigned and stored in an electronic format. In some cases, the BOL and proof of delivery documents can automatically be saved and/or sent to a remote location for viewing, saving, and archiving.

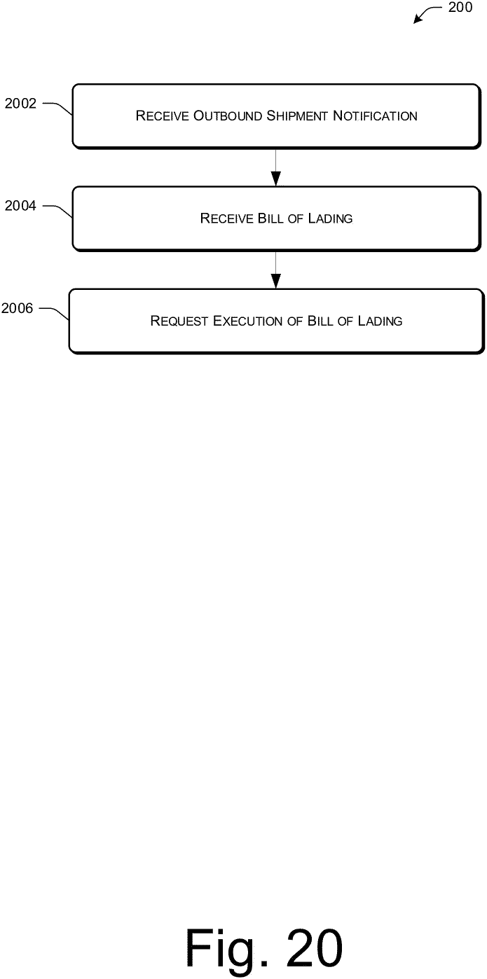

When a driver is leaving a warehouse facility after making a pick up a BOL must be generated and signed by the driver. FIG. 20 illustrates a partial process flow for an outbound transaction when a driver is making a pick up. At block 2002, the system receives an outbound shipment notification. The notification may be an electronic notification that is entered into the system either automatically, manually, or a some combination of automated and manual steps.

At block 2004, a bill of lading (BOL) is created and received by the scheduling system. The BOL may be received from a customer’s system and may be attached to the record in the scheduling system as a document that may be viewable, printable, and/or downloadable. An electronic communication that includes a request to sign the BOL may be sent to the driver once the shipment has been loaded on the driver’s vehicle. In some cases, the driver may receive a text message or an email message that includes a link to view and sign the BOL document. The driver may select or follow the link to open a web page in a web browser that displays the BOL document with a mechanism for the driver to electronically sign the BOL.

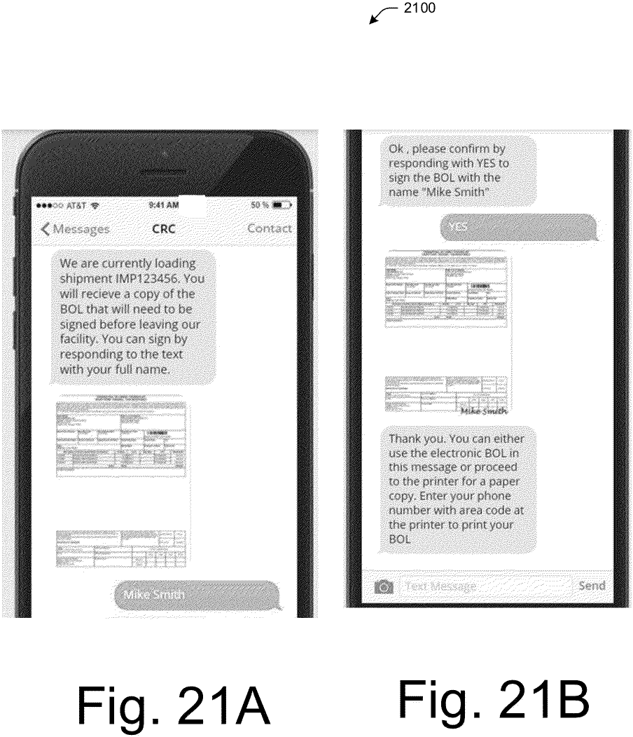

In some cases, as illustrated in FIGS. 21A and 21B, the electronic signing of the BOL may be handled within a text messaging application. For example, an MMS message that includes a copy of the BOL may be sent to the driver. For example, the BOL could take the form of a rendered photo of the BOL that is included with or attached to the text message. The text message asks the driver to initiate the signing of the BOL by sending a response text message that includes the driver’s name. Once the driver has sent a response text message with a name, the system sends the driver a second text message that includes the name provided by the driver and asking the driver to response with a YES message to complete the signature process. When the driver sends the response message with a YES, the process is complete. At that point, the system may send the driver a final message indicating the BOL signature process has been completed, and also indicating that the user could obtain a printed copy of the BOL from a kiosk or some other locations, such as an administrative office, should a printed copy be necessary.

According to embodiments described herein, systems and methods of picking up and delivering goods is provided with increased efficiency, through a touchless process, and by utilizing electronic communications. According to some embodiments, a driver can check into a facility, have their trailer loaded to pick up a shipment, and receive and sign BOL documents, all without exiting their vehicle. Similarly, a driver can check into a facility, receive a dock assignment, have their trailer unloaded, and receive signed proof of delivery documents without having to exit the vehicle. This results in a touchless process in which there is no human-to-human interaction in order to load or unload a shipment from a trailer.

According to some embodiments, upon check out after receiving a shipment, a driver may interact with a check-out kiosk, which may be the same kiosk or a different kiosk as the check-in kiosk. The check-out kiosk may print a BOL document, a seal that the driver can affix to the trailer, and/or other documentation. Of course, a physical BOL may be printed at the warehouse and put into the trailer in addition to or as an alternative to an electronic BOL. In some embodiments, the kiosk may print a seal that the driver then secures to the trailer as evidence that the trailer has not been opened between the time of loading and the time of unloading. In some embodiments, the kiosk may print a weight ticket, a time stamp and/or other documents.

In some embodiments, a check-in kiosk is located remotely from the warehouse facility. For instance, a check-in kiosk may be located at a truck stop or lounge area and a driver may be directed to the kiosk in order to interact with administrators and receive dock assignments. Thereafter, the driver may proceed directly to an assigned loading dock at a warehouse facility, or the driver may be directed to wait for a loading dock to become available. If the kiosk is located at a facility remote from the warehouse, this would allow the driver to wait at the off-site location, thereby easing traffic in an around the warehouse facility.

In many cases, interaction with an administrator via a check-in kiosk enables a driver to verbally provide pertinent information about the delivery. The administrator may input the information, pull additional information from a database, or a combination of both in order to verify and schedule a delivery or a pick up. In any event, the driver may not be required to enter any information at the kiosk, but rather, may provide information verbally in order to check-in. During loading and/or unloading of the shipment, the warehouse operators may capture one or more images of the shipment. Such images may be uploaded to the system as further evidence of the shipment, such as the quality, quantity, any damage, and the like.

In many prior systems, upon arriving at a warehouse facility, a driver was required to park the vehicle, enter a guard shack or office, fill out and sign paperwork, and then get back into the vehicle to continue the process. Through the use of the disclosed systems, the driver never needs to leave the vehicle as all communication can be performed through the kiosk and/or via electronic communications. Any required physical documents, such as a cargo seal or a BOL can be printed at a kiosk.

The electronic communications can be exchanged between the scheduling system and the driver via systems that are not reliant upon a driver having any specific type of mobile communications device or any specific software. The most common example of this is text messages that are exchanged via a smartphone’s native text messaging service. However, such electronic communications need not be limited to text messages send and received via a smartphone’s native messaging service.

For example, most individuals have an email address which can be used to exchange email messages via a smartphone or another type of mobile computing device. Also, many individuals maintain usernames or text messaging addresses that can be used to send and receive electronic messages via third party messaging services. The scheduling system could communication with a driver via any or multiple ones of these electronic communications systems.

Furthermore, in typical processes where a driver needs to interact with personnel in a guard shack or office, the warehouse facility is required to have additional staff members to perform check-in and check-out with drivers. This results in additional employees for the warehouse facility. Through the disclosed systems and methods, the personnel required for check-in and/or check-out may be located remotely from the warehouse facility. Also, a single employee may provide check-in and check-out services for a plurality of warehouse facilities.

In the foregoing example, when a driver arrived to make a delivery or pick up, the driver interacted with administrative personnel to check in and receive a loading dock assignment using a kiosk at either the warehouse facility, or a facility off-site but nearby the warehouse. In alternate methods, it is not necessary to use a kiosk to accomplish the check in procedures or any of the other steps. Instead, all communications to and from the driver could be accomplished electronically via a driver’s smartphone, tablet or laptop computer or some other type of mobile computhing device. Such methods and procedures are discussed below.

In some cases when a arrives at a facility to make a delivery or pick up, the driver is directed by signage to place a telephone call or send a text message to a telephone number associated with administrative personnel 410 in order to check-in for their delivery or pick-up appointment. Such signage may include directions to driver that they may not enter the facility.

The driver then calls telephone number or sends a text message to the telephone number associated with administrative personnel 410 to inform the administrative personnel they have arrived for an appointment. The driver and the administrative personnel then interact via the telephone call or additional text messages to inform the administrative personnel of the relevant appointment information. Such information can include a BOL Number, a carrier name, contact information for the driver in the form of a driver’s telephone number or other electronic messaging contact identifier, a truck number, a trailer number, a trailer size, a DOT number a seal number and information about the type of equipment that will be required to perform the loading/unloading operation.

If the appointment is for a pick up, then the information can include information about how the goods are to be loaded and secured, a destination, and if there are multiple destinations, all destinations may be itemized in the order of planned delivery to ensure the load corresponds with the intended order of deliveries.

After receiving all relevant information, the administrative personnel 410 sends an electronic communication to the driver, such as sending a SMS message to driver’s smarktphone, to confirm the accuracy of the received information Such an electronic message also instructs the driver to respond with an electronic message back to the administrative personnel indicating whether the information is correct. If driver indicates the information is not correct, the driver and the administrative personnel could further interact to correct any of the required information.

Once the driver indicates the information is correct, the administrative personnel 410 selects an appropriate loading dock and sends an electronic communication back to the driver informing the driver of the selected loading dock. That message could indicate that the driver is to proceed immediately to the assigned loading dock, or that the driver will need to wait for the loading dock to be available. If the driver must wait, the electronic communication sent to the driver may provide instructions about where the driver should wait. Also, if the driver must wait, the administrative personnel would then send a follow-up communication to the driver when the loading dock is available indicating that the driver should now proceed to the assigned loading dock.

Upon assignment of a loading dock, the administrative personnel may cause a message to be sent to the warehouse operators at the loading/unloading facility as to which loading dock was selected and indicating that the driver is about to arrive for a pick up or delivery. Such a message may also indicate whether any specific equipment will be required to accomplish the loading/unloading operation. Loading/unloading personnel then proceed to the assigned loading dock

After opening the trailer, loading/unloading personnel may review the truck and trailer number provided and confirm the validity of information before proceeding with loading or unloading. If the information is valid, then the loading/unloading personnel may proceed with loading/unloading. If the information is invalid, then the loading/unloading personnel may report any discrepancies to clerical staff at the warehouse 64 and/or to administrative personnel 410 for further instruction.

If the appointment is for a delivery, then the driver may be advised via an electronic communication to place delivery paperwork, such as a BOL, in the back of the trailer for warehouse receiving. After unloading the delivery, the delivery paperwork may be signed by personnel of unloading/loading facility 64 to provide driver with proof of delivery. If the appointment is for a pick-up, then the driver may be advised via an electronic communication that a BOL will be placed on the last pallet in his trailer.

After the loading/unloading operation is complete, the loading/unloading personnel may send an electronic communication to the administrative personnel indicating that the loading/unloading process is complete. The loading/unloading personnel may also notify clerical staff at loading/unloading facility 64 that the loading/unloading operation is complete. Such electronic communications may cause a loading dock schedule displayed on the administrator interface 420 to indicate that the loading dock is now available for additional loading/unloading appointments.

One or more of the electronic communications sent by the loading/unloading personnel may cause an electronic message to be sent to the driver advising that loading/unloading operation is complete. Alternatively, or in addition, the administrative personnel 410 may cause an electronic communication to be sent to the driver advising that loading/unloading operation is complete. The driver may then depart the warehouse facility, and may provide facility exit information.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

While embodiments of the present invention are described with regard to freight delivery and pickup, embodiments may also be implemented in various other applications, including independent identity verification of drivers, individuals, card members of various organizations, etc, through kiosk systems, DOT readers and/or related software and/or systems as described herein.

While the embodiments are described with reference to various implementations and exploitations, it will be understood that these embodiments are illustrative and that the scope of the inventions is not limited to them. Many variations, modifications, additions, and improvements are possible. Further still, any steps described herein may be carried out in any desired order, and any desired steps may be added or deleted.

What is claimed is:

1. A method of facilitating the delivery and pick up of goods from a warehouse, comprising:
receiving information from a driver of a delivery vehicle when the driver arrives at a loading/unloading facility or at a waiting facility near the loading/unloading facility for a scheduled appointment to deliver or pick up a shipment of goods, wherein the information is received from the driver via an audio or video telephone call or via at least one informational electronic communication sent from a driver’s mobile computing device;
identifying a loading dock at the loading/unloading facility where the driver can accomplish the scheduled appointment to deliver or pick up a shipment of goods;
informing the driver of the identified loading dock via an audio or video telephone call or via a directing electronic communication sent to the driver’s mobile computing device;
receiving an electronic communication indicating that a loading or unloading operation associated with the scheduled appointment has been completed; and
conducting a departure operation with the driver via an audio or video telephone call or via at least one departure electronic communication.

2. The method of claim 1, wherein the information received from the driver includes a driver identifier that can be used to send electronic communications to the driver’s mobile computing device.

3. The method of claim 1, wherein at least some of the information received from the driver is received via a kiosk at the loading/unloading facility or at the waiting facility.

4. The method of claim 1, further comprising:
causing a confirmation electronic communication to be sent to the driver’s mobile computing device that includes at least some of the information received from the driver and that requests that the driver send a reply electronic communication that indicates whether the information in the confirmation electronic communication is accurate; and
receiving a reply electronic communication from the driver’s mobile computing device, wherein the step of informing the driver of the identified loading dock is only performed if the reply electronic communication indicates that the information in the confirmation electronic communication is accurate.

5. The method of claim 1, wherein the scheduled appointment is for a delivery, and wherein conducting a departure operation with the driver comprises sending at electronic communication to the driver’s mobile computing device that includes a delivery receipt or proof of delivery.

6. The method of claim 1, wherein the scheduled appointment is for a pick up, and wherein conducting a departure operation with the driver comprises:
causing a loaded electronic communication to be sent to the driver’s mobile computing device that includes or that links to a draft bill of lading document, the loaded electronic communication requesting that the driver send a response electronic communication with a driver identifier;
receiving from the driver’s mobile computing device a response electronic communication that includes a driver identifier; and
saving at least a portion of the received response electronic communication in a database as proof that the driver sent the response electronic communication.

7. The method of claim 1, wherein informing the driver of the identified loading dock comprises causing a directing electronic communication to be sent to the driver’s mobile computing device, wherein the directing electronic communication includes directions and/or a map indicating how to locate the identified loading dock, or a link to directions and/or a map indicating how to locate the identified loading dock.

8. The method of claim 1, wherein the scheduled appointment is for a pick up, and wherein the method further comprises causing a seal to be printed for the driver, the seal being configured to be applied to the delivery vehicle in such a way that so long as the seal remains unbroken, the unbroken seal will indicate that the delivery vehicle has not been opened since it was loaded at the loading/unloading facility.

9. The method of claim 8, wherein the seal is printed at a kiosk located at the loading/unloading facility or at the waiting facility.

10. The method of claim 1, wherein the steps of the method are performed by administrative personnel using a scheduling system, and wherein the administrative personnel is located apart from the loading/unloading facility.

11. A non-transitory computer readable medium bearing instructions which, when run by one or more processors, cause the one or more processors to perform a method of facilitating the delivery and pick up of goods from a warehouse, the method comprising:
receiving information from a driver of a delivery vehicle when the driver arrives at a loading/unloading facility or at a waiting facility near the loading/unloading facility for a scheduled appointment to deliver or pick up a shipment of goods, wherein the information is received from the driver via an audio or video telephone call or via at least one informational electronic communication sent from a driver’s mobile computing device;
identifying a loading dock at the loading/unloading facility where the driver can accomplish the scheduled appointment to deliver or pick up a shipment of goods;
informing the driver of the identified loading dock via an audio or video telephone call or via a directing electronic communication sent to the driver’s mobile computing device;
receiving an electronic communication indicating that a loading or unloading operation associated with the scheduled appointment has been completed; and
conducting a departure operation with the driver via an audio or video telephone call or via at least one departure electronic communication.

12. The non-transitory computer readable medium of claim 11, wherein the information received from the driver includes a driver identifier that can be used to send electronic communications to the driver’s mobile computing device.

13. The non-transitory computer readable medium of claim 1, wherein at least some of the information received from the driver is received via a kiosk at the loading/unloading facility or at the waiting facility.

14. The non-transitory computer readable medium of claim 11, wherein the method performed by the one or more processors further comprises:
causing a confirmation electronic communication to be sent to the driver’s mobile computing device that includes at least some of the information received from the driver and that requests that the driver send a reply electronic communication that indicates whether the information in the confirmation electronic communication is accurate; and
receiving a reply electronic communication from the driver’s mobile computing device, wherein the step of informing the driver of the identified loading dock is only performed if the reply electronic communication indicates that the information in the confirmation electronic communication is accurate.

15. The non-transitory computer readable medium of claim 11, wherein the scheduled appointment is for a delivery, and wherein conducting a departure operation with the driver comprises sending at electronic communication to the driver’s mobile computing device that includes a delivery receipt or proof of delivery.

16. The non-transitory computer readable medium of claim 11, wherein the scheduled appointment is for a pick up, and wherein conducting a departure operation with the driver comprises:
causing a loaded electronic communication to be sent to the driver’s mobile computing device that includes or that links to a draft bill of lading document, the loaded electronic communication requesting that the driver send a response electronic communication with a driver identifier;
receiving from the driver’s mobile computing device a response electronic communication that includes a driver identifier; and
saving at least a portion of the received response electronic communication in a database as proof that the driver sent the response electronic communication.

17. The non-transitory computer readable medium of claim 11, wherein informing the driver of the identified loading dock comprises causing a directing electronic communication to be sent to the driver’s mobile computing device, wherein the directing electronic communication includes directions and/or a map indicating how to locate the identified loading dock, or a link to directions and/or a map indicating how to locate the identified loading dock.

18. The non-transitory computer readable medium of claim 11, wherein the scheduled appointment is for a pick up, and wherein the method performed by the one or more processors further comprises causing a seal to be printed for the driver, the seal being configured to be applied to the delivery vehicle in such a way that so long as the seal remains unbroken, the unbroken seal will indicate that the delivery vehicle has not been opened since it was loaded at the loading/unloading facility.

19. The non-transitory computer readable medium of claim 18, wherein the seal is printed at a kiosk located at the loading/unloading facility or at the waiting facility.
